(19) United States
(12) Patent Application Publication
(10) Pub. No.: US 2010/0254037 A1
(43) Pub. Date: Oct. 7, 2010

(54) INFORMATION PROCESSING SYSTEM AND METHOD FOR ACCESSING INFORMATION PROCESSING DEVICE

(75) Inventor: Tooru SHINOHARA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/821,051

(22) Filed: Jun. 22, 2010

Related U.S. Application Data
(63) Continuation of application No. PCT/JP2007/075306, filed on Dec. 28, 2007.

(51) Int. Cl. G11B 20/10

(52) U.S. Cl. 360/39; G9B/20.009

(57) ABSTRACT

According to one embodiment, an information processing system includes a plurality of information processing devices connected to one another and capable of transmitting/receiving data to/from one another. One information processing device includes a determiner configured to determine whether an address level included in a transmission signal transmitted from another information processing device is for specifying the one information processing device based on information on the address level, and a data receiver configured to receive real data included in the received transmission signal when the determiner determines that the address level is for specifying the one information processing device. The another information processing device includes an address-data converter configured to convert address data for specifying the one information processing device to a corresponding address level, and a transmitter configured to transmit the transmission signal including information on the address level obtained by the address-data converter and the real data for the one information processing device.

### CROSS-REFERENCE TO RELATED APPLICATIONS

This application is a continuation of PCT international application Ser. No. PCT/JP2007/075306 filed on Dec. 28, 2007 which designates the United States, the entire contents of which are incorporated herein by reference.

### BACKGROUND

1. Field

One embodiment of the invention relates to an information processing system, and a method for accessing an information processing device, and more particularly to an information processing system in which information processing devices are connected to one another and are capable of transmitting/receiving data to/from one another, and a method for accessing the information processing device.

2. Description of the Related Art

As an example of a system in which a plurality of magnetic disk recording/reproducing devices, each comprising a magnetic disk drive (namely a hard disk drive, for example) or the like, is connected to a host magnetic disk control device via a communication line, consider an information processing system in which a plurality of information processing devices is connected to one another and is capable of transmitting/receiving data to/from one another.

When a specific magnetic disk recording/reproducing device is accessed by the host magnetic disk control device in this system, the host magnetic disk control device transmits a signal specifying an address specific to the magnetic disk recording/reproducing device to be accessed and receives a signal in response thereto so as to confirm whether or not the magnetic disk recording/reproducing device is in an accessible state. After confirming that the magnetic disk recording/reproducing device to be accessed is in an accessible state in this manner, the host magnetic disk control device performs reading/writing operation of information from/to the magnetic disk recording/reproducing device using the communication line.

In such a case, according to a conventional technology, the host magnetic disk control device first transmits the address specific to the magnetic disk recording/reproducing device to be accessed, then the magnetic disk recording/reproducing device transmits a signal indicating that it can receive data to the host magnetic disk control device. The host magnetic disk control device receives the signal transmitted from the magnetic disk recording/reproducing device to confirm that the magnetic disk recording/reproducing device can receive the data and then performs transmission/reception of actual data.

In other words, the host magnetic disk control device is required to transfer data of address (hereinafter referred to simply as address data) of the magnetic disk recording/reproducing device to the magnetic disk recording/reproducing device prior to transmission/reception of data to/from the magnetic disk recording/reproducing device to perform data writing/reading operation, and thus the time for such transfer is required.

The time required for transferring the address data is relatively short and thus may not be a serious disadvantage when the time for transmission/reception of actual data that is subsequently performed, namely the time for transmission/reception of data (hereinafter referred to simply as real data) to be read/written from/to the magnetic disk recording/reproducing devices, is comparatively long. However, when the time for transmission/reception of the real data is comparatively short and the transmission/reception operation is performed multiple times, the address data is required to be transferred each time, which results in a considerable amount of time required for transfer of the address data. Consequently, reduction of such time is desired. For the examples of the conventional technology, see, for example, Japanese Patent No. 3024444 and Japanese Utility Model Registration No. 2515320.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram for explaining an outline of an information processing system according to an embodiment of the invention;

FIG. 2 is an exemplary block diagram for explaining a configuration for data transmission in each of both a magnetic disk control device and magnetic disk recording/reproducing devices illustrated in FIG. 1 in the embodiment;

FIG. 3 is an exemplary block diagram for explaining a configuration for data reception in each of both the magnetic disk control device and the magnetic disk recording/reproducing devices illustrated in FIG. 1 in the embodiment;

FIG. 4 is an exemplary circuit diagram of a demodulator for reception in each of the magnetic disk recording/reproducing devices in FIG. 1, for explaining a function of separating serial data, a synchronization signal and an address level from a pulse signal in a laser beam and a function of determining a corresponding magnetic disk recording/reproducing device based on the address level in the embodiment;

FIG. 5 is an exemplary time chart of signals in a magnetic disk control device that performs accesses in a method for accessing an information processing device according to a conventional technology presented for comparison;

FIG. 6 is an exemplary time chart of signals in a magnetic disk control device that performs accesses in a method for accessing an information processing device in the information processing system in the embodiment;

FIG. 7 is an exemplary time chart for explaining a state in which a plurality of magnetic disk recording/reproducing devices is sequentially accessed in the information processing system in the embodiment;

FIG. 8 is an exemplary operation flowchart for explaining a flow of a calibration operation at power-on in the information processing system in the embodiment;

FIG. 9 is an exemplary operation flowchart for explaining a flow of a calibration operation upon detection of an error in the information processing system in the embodiment;

FIG. 10 is an exemplary time chart for explaining the calibration operation upon detection of an error illustrated in FIG. 9 in the embodiment; and

FIG. 11 is an exemplary hardware block diagram for explaining a configuration of a computer mounted on a magnetic disk control LSI in each of the magnetic disk control device and the magnetic disk recording/reproducing devices in the information processing system in the embodiment.

### DETAILED DESCRIPTION

Various embodiments according to the invention will be described hereinafter with reference to the accompanying drawings. In general, according to one embodiment of the invention, an information processing system comprises a plurality of information processing devices connected to one another and capable of transmitting/receiving data to/from one another. One information processing device among the plurality of information processing devices comprises a determiner configured to determine whether or not an address level included in a transmission signal transmitted from another information processing device among the information processing devices is for specifying the one information processing device based on information on the address level, and a data receiver configured to receive real data included in the received transmission signal when the determiner determines that the address level included in the transmission signal is for specifying the one information processing device. The another information processing device comprises an address-data converter configured to convert address data for specifying the one information processing device to a corresponding address level, and a transmitter configured to transmit the transmission signal including information on the address level obtained by the address-data converter and the real data for the one information processing device.

According to another embodiment of the invention, a method for accessing an information processing device by which one information processing device of a plurality of information processing devices accesses another information processing device in an information processing system in which the information processing devices are connected to one another and are capable of transmitting/receiving data to/from one another, the method comprises: converting, by the one information processing device, address data for specifying the another information processing device to a corresponding address level; transmitting, by the one information processing device, a transmission signal including information on the address level obtained in the converting and real data for the another information processing device; determining, by the another information processing device, based on the information on the address level included in the transmission signal transmitted from the one information processing device, whether or not the address level is for specifying the another information processing device; and receiving, by the another information processing device, the real data included in the received transmission signal when it is determined in the determining that the address level included in the transmission signal is for specifying the another information processing device.

An embodiment of the invention will be described in detail below.

According to the embodiment of the invention, the time for transfer of address data can be shortened by using a laser beam level itself of a laser beam, which allows signal transmission in a reasonable manner, as the address level so as to shorten the time required for transferring address data for specifying an information processing device to which data is to be transferred in an information processing system in which a plurality of information processing devices is connected to one another and is capable of transferring data from/to one another.

According to the embodiment of the invention, in a configuration comprising a plurality of magnetic disk recording/reproducing devices that are each information processing devices connected to a communication line of optical fibers via optical fiber interfaces and a magnetic disk control device, the magnetic disk control device specifies an arbitrary magnetic disk recording/reproducing device by changing an output level of the laser beam when the magnetic disk control device specifies each magnetic disk recording/reproducing device and transfers real data thereto.

Specifically, the host magnetic disk control device sets an output level of the laser beam to be output to the optical fiber as the optical transfer path to be a predetermined address level corresponding to an address of each magnetic disk recording/reproducing device, specifies a magnetic disk recording/reproducing device using the address level and accesses to the magnetic disk recording/reproducing device. To attain the configuration, a modulator for transmission comprising an optical modulator and an optical transmitter (such as a semiconductor laser) and a demodulator for reception comprising an optical receiver and a demodulator are provided in each of both the magnetic disk recording/reproducing devices and the host magnetic disk control device, thereby allowing real data exchange bidirectionally between the magnetic disk control device and each magnetic disk recording/reproducing device.

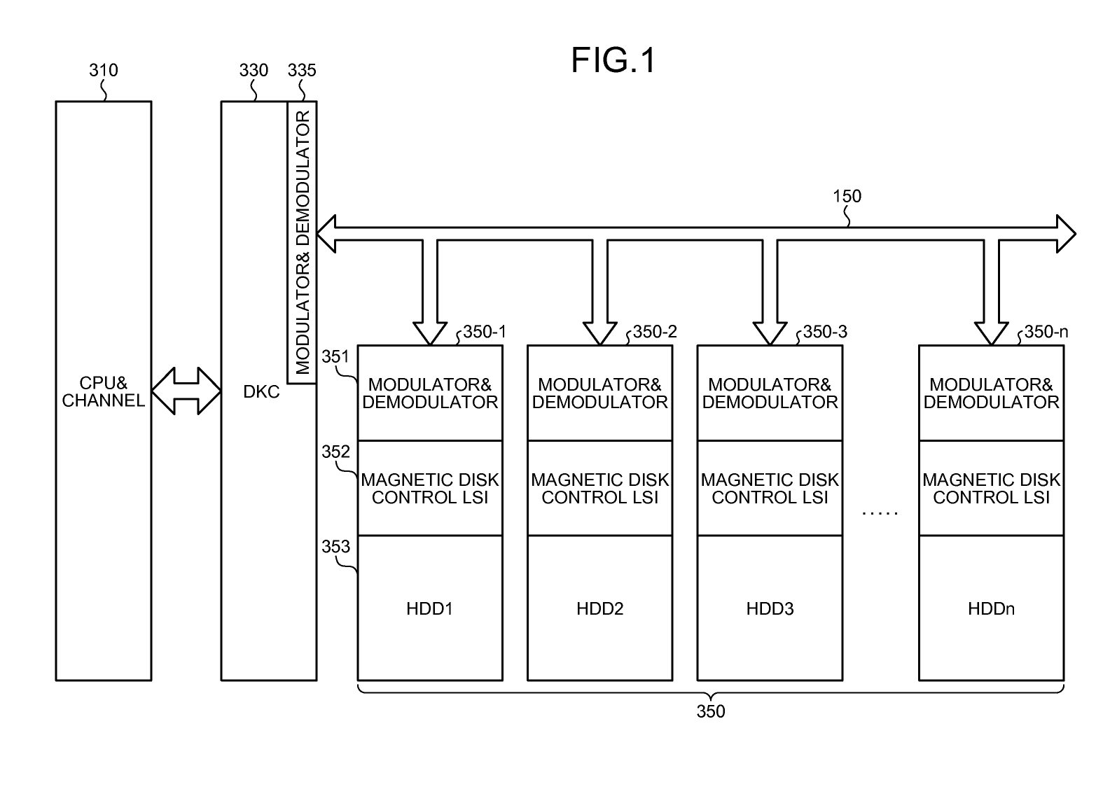

FIG. 1 is a block diagram illustrating a configuration of the information processing system according to the embodiment of the invention.

The information processing system according to the embodiment of the invention comprises, as illustrated in FIG. 1, a device 310 in which a channel is connected under the control of an uppermost CPU, a magnetic disk control device (DKC) 330 controlled by the device 310, and a plurality of magnetic disk recording/reproducing devices 350-1, 350-2, . . . , 350-n (hereinafter, may also be collectively referred to as magnetic disk recording/reproducing devices 350) connected with the magnetic disk control device 330 via an optical transfer path 150 of optical fibers so that data can be mutually transmitted/received therebetween.

The magnetic disk control device 330 comprises a modulator and demodulator 335, the modulator comprising an optical modulator for transmission and the demodulator comprising an optical demodulator for reception, as described above. The modulator and demodulator 335 provide functions allowing transmission/reception of data with the magnetic disk recording/reproducing devices 350 under their control via the optical transfer path 150.

Each magnetic disk recording/reproducing device 350 similarly comprises a modulator and demodulator 351, the modulator comprising an optical modulator for transmission and the demodulator comprising an optical demodulator for reception, a magnetic disk control LSI 352 and a magnetic disk drive (HDD) 353. The modulator and demodulator 351 provide functions allowing transmission/reception of data with the magnetic disk control device 330 that is a host device thereof via the optical transfer path 150.

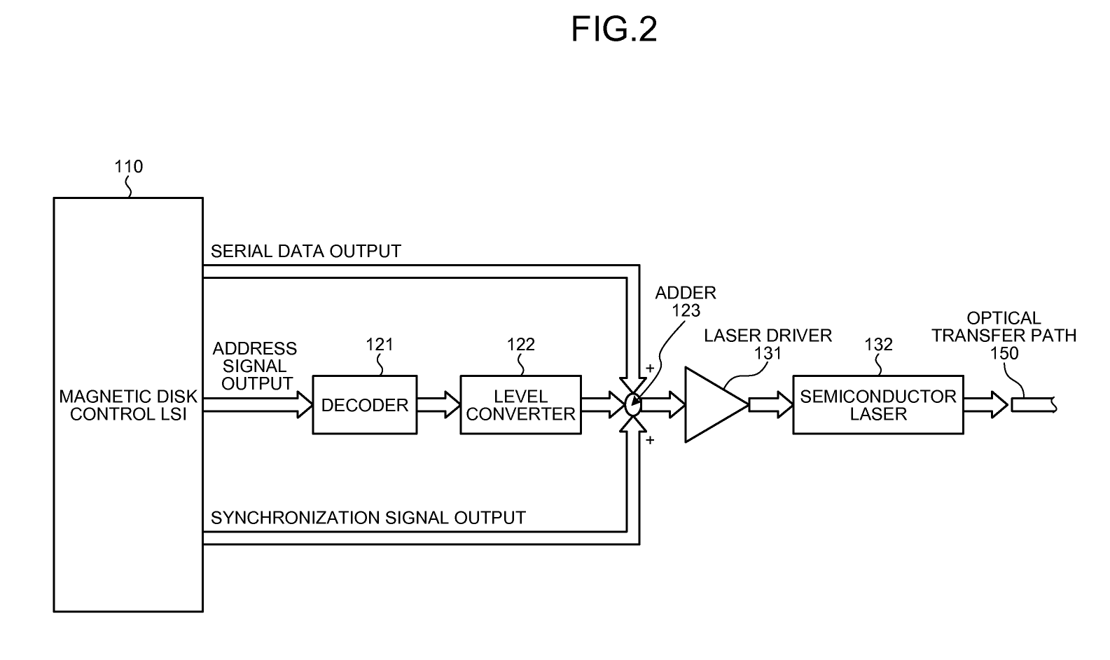

FIG. 2 is a block diagram for explaining a configuration of a modulator for transmission in each of both the magnetic disk control device 330 and the magnetic disk recording/reproducing devices 350.

In FIG. 2, each of both the magnetic disk control device 330 and the magnetic disk recording/reproducing devices 350 is provided with a magnetic disk control LSI 110 (corresponding to the magnetic disk control LSI 352 in the magnetic disk recording/reproducing devices 350), a decoder 121, a level converter 122, an adder 123, a laser driver 131, and a semiconductor laser 132. Among these components, the decoder 121, the level converter 122, the adder 123, the laser driver 131 and the semiconductor laser 132 are comprised in the modulator.

According to this configuration, serial data (namely, real data), an address signal including address data, and a synchronization signal are output from the magnetic disk control LSI 110 in each of the magnetic disk control device 330 and the magnetic disk recording/reproducing devices 350.

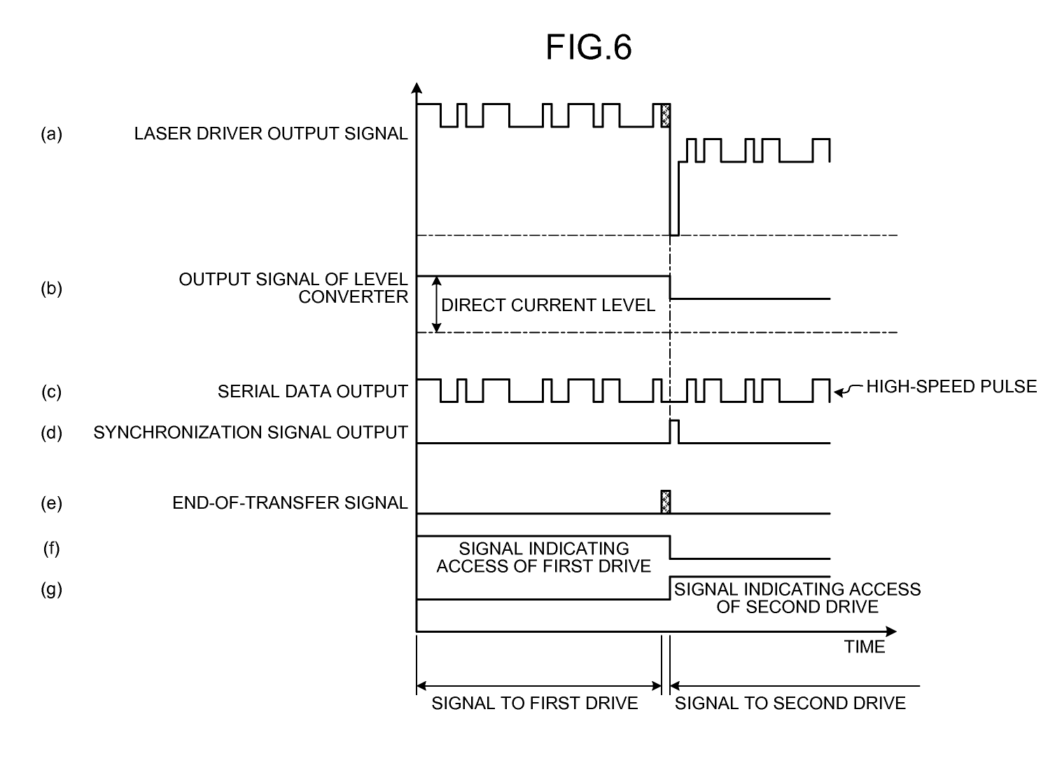

The address signal is converted into a decoder pulse signal at the decoder 121, and further converted into a signal having an address level corresponding to the address data at the level converter 122. The address level is added to the serial data and the synchronization signal at the adder 123. Specifically, as illustrated for example in FIG. 6 which will be described later, the address level (FIG. 6(b)) is added to the level (FIG. 6(c)) of a pulse signal representing the serial data, and an output level of the adder 123 is set to zero at a timing of a pulse of the synchronization signal (FIG. 6(d)), so that the waveform as illustrated in FIG. 6(a) is obtained.

The laser driver 131 drives the semiconductor laser 132 according to the level of the signal obtained at the adder 123, and thus a laser beam having light intensity in the waveform as illustrated in FIG. 6(a) is output from the semiconductor laser 132.

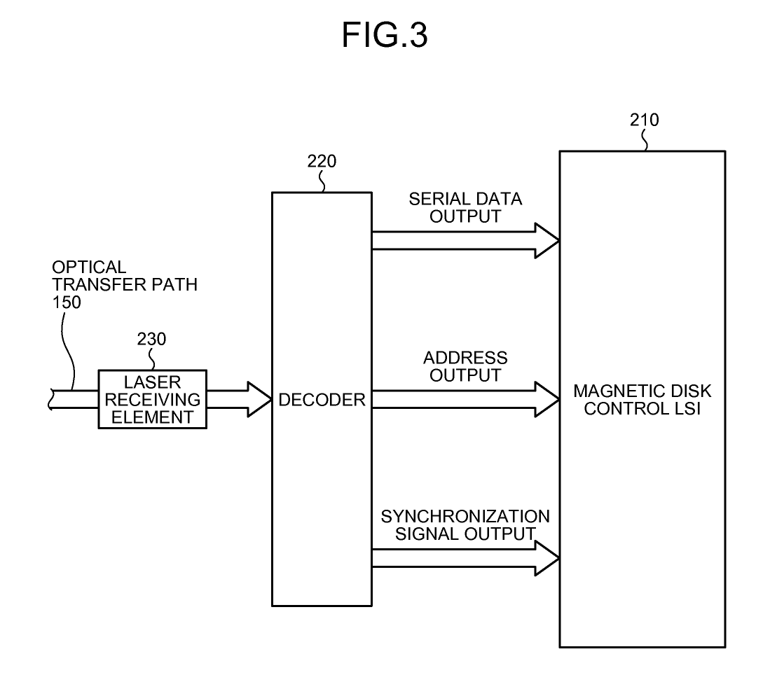

FIG. 3 is a block diagram for explaining a configuration of the demodulator for reception in each of both the magnetic disk control device 330 and the magnetic disk recording/reproducing devices 350.

As illustrated in FIG. 3, each of both the magnetic disk control device 330 and the magnetic disk recording/reproducing devices 350 is provided with a laser receiving element 230, a decoder 220, and a magnetic disk control LSI 210 (corresponding to the magnetic disk control LSI 352 in the magnetic disk recording/reproducing devices 350). Among these components, the laser receiving element 230 and the decoder 220 are comprised in the demodulator.

According to this configuration, a laser beam received via the optical transfer path 150 is converted into an electrical signal at the laser receiving element 230 to obtain a pulse signal in each of the magnetic disk control device 330 and the magnetic disk recording/reproducing devices 350. By means of a separating function of the decoder 220, the serial data, the address level, and the synchronization signal are obtained from the pulse signal, which are then input to the magnetic disk control LSI 210.

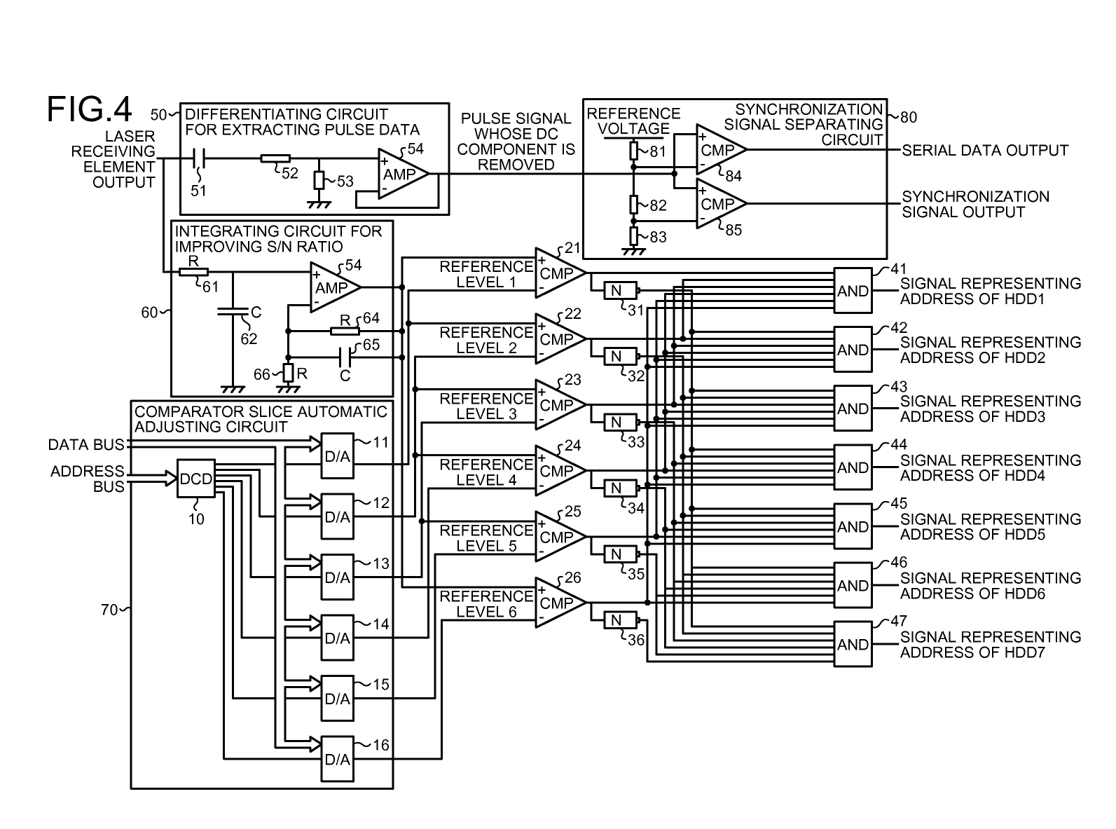

FIG. 4 is a circuit diagram for explaining functions of the demodulator for reception in each of the magnetic disk recording/reproducing devices 350 as an example. The functions are a function of separating serial data, a synchronization signal and an address level from a pulse signal included in a received laser beam and obtained by the laser receiving element 230 as described above, and a function of determining each magnetic disk recording/reproducing device 350 based on the address level.

As illustrated in FIG. 4, the pulse signal (namely, a laser receiving element output in FIG. 4) obtained from the laser receiving element 230 is input to a differentiating circuit 50 and an integrating circuit 60. The differentiating circuit 50 comprises a capacitor 51, resistors 52, 53 and an operational amplifier 54, and has a function of removing a direct-current component of a pulse signal obtained from the laser receiving element 230. The integrating circuit 60 comprises a resistor 61, a capacitor 62, the operational amplifier 54, resistors 64, 66 and a capacitor 65, and has a function of extracting a direct-current component of the pulse signal obtained from the laser receiving element 230. Since the operation and function of each of the differentiating circuit 50 and the integrating circuit 60 are similar to those of a known differentiating circuit and integrating circuit, the description thereof is omitted.

An output of the differentiating circuit 50 is input to a synchronization signal separating circuit 80. The synchronization signal separating circuit 80 comprises resistors 81 to 83 and comparators 84, 85, and has a function of separating the pulse signal supplied from the differentiating circuit 50 into a serial data component that is of a relatively high level and a synchronization signal that is of a relatively low level.

The output of the laser receiving element 230 contains, as illustrated in FIG. 6(a), a serial data component that has been output for the magnetic disk recording/reproducing devices 350 and a synchronization signal component representing a timing for switching the access destination for transferring the serial data between different magnetic disk recording/reproducing devices, where the level of the synchronization signal component is lower than that of the serial data component. This is because the output of the adder 123 is set to zero at the timing of the synchronization signal in transmission, as described above with reference to FIG. 2. Thus, the synchronization signal can be separated from the signal, whose direct-current component is removed by the differentiating circuit 50, at the synchronization signal separating circuit 80 based on a difference in the levels.

As illustrated in FIG. 4, the demodulator for reception in each of both the magnetic disk control device 330 and the magnetic disk recording/reproducing devices 350 comprises an automatic adjusting circuit 70 that automatically adjusts reference levels to be supplied to comparators 21 to 26 each configured to compare the address level with the reference level to determine the magnetic disk recording/reproducing device 350 corresponding to the address level, which will be described later.

The automatic adjusting circuit 70 comprises D/A converters 11 to 16 that generate analog values of the reference levels to be supplied to the comparators 21 to 26, respectively, based on bit data supplied from the magnetic disk control LSI 210 and a decoder 10 that outputs a signal for selecting any one of the D/A converters based on address data supplied from the magnetic disk control LSI 210 via an address bus.

In the automatic adjusting circuit 70, each of the D/A converters 11 to 16, which is selected according to the address data supplied from the address bus, generates the reference level based on the bit data supplied via a data bus and provides the reference level to the corresponding comparator 21 to 26.

A direct-current level extracted by the integrating circuit 60, that is the address level, is supplied to the comparators 21 to 26 and compared with the reference level at each of the comparators 21 to 26. Each of the comparators 21 to 26 outputs “1” when the address level input from the integrating circuit 60 is higher than the reference level supplied from the automatic adjusting circuit 70, or “0” when the address level is lower than the reference level.

The outputs of the comparators 21 to 26 are respectively supplied to AND circuits 41 to 47 respectively corresponding to the magnetic disk recording/reproducing devices 350-1 to 350-7. The outputs of the comparators 21 to 26 are also inverted in inverting circuits 31 to 36 and supplied to the AND circuits 42 to 47, respectively.

Among the reference levels that are supplied from the automatic adjusting circuit 70 to the comparators 21 to 26, the reference level 1 supplied to the comparator 21 is the highest, and the reference levels 2 to 6 that are respectively supplied to the comparators 22 to 26 are set to be lower than the reference level 1 in a stepwise manner in this order, so that the reference level 6 is set to be the lowest.

The reference levels 1 to 6 are also set to have the following relationships with the address levels 1 to 7 for specifying the respective magnetic disk recording/reproducing devices 350-1 to 350-7. Among the address levels 1 to 7 for specifying the respective magnetic disk recording/reproducing devices 350-1 to 350-7, the address level 1 is the highest, and the address levels 2 to 7 are set to be lower than the address level 1 in a stepwise manner in this order, so that the address level 7 is set to be the lowest.

Specifically, the address level 1 for specifying the magnetic disk recording/reproducing device 350-1 is higher than the reference level 1, the address level 2 for specifying the magnetic disk recording/reproducing device 350-2 is lower than the reference level 1 but higher than the reference level 2, the address level 3 for specifying the magnetic disk recording/reproducing device 350-3 is lower than the reference level 2 but higher than the reference level 3, . . . , the address level 6 for specifying the magnetic disk recording/reproducing device 350-6 is lower than the reference level 5 but higher than the reference level 6, and the address level 7 for specifying the magnetic disk recording/reproducing device 350-7 is lower than the reference level 6.

Consequently, when the address level supplied from the integrating circuit 60 is the address level 1 for specifying the magnetic disk recording/reproducing device 350-1, the address level 1 is higher than the reference level 1 that is supplied to the comparator 21 as described above, and further, the address level 1 is higher than any of the reference levels 1 to 6 because the reference levels 2 to 6 are set to be lower than the reference level 1 in a stepwise manner in this order. Consequently, the address level is determined to be higher than the reference level at all the comparators 21 to 26, and all the comparators 21 to 26 output “1”.

Consequently, all the inputs supplied to the AND circuit 41 are “1”, and thus the AND circuit 41 outputs “1”. On the other hand, a signal obtained by inverting the output from the comparator 21 at the inverting circuit 31 is supplied to the other AND circuits 42 to 47. Since the output from the comparator 21 is “1” as described above, the inverted signal of the output represents “0”. The AND circuits 42 to 47, to which the signal representing “0” is supplied, output “0”. Therefore, in this case, only the output of the AND circuit 41 corresponding to the magnetic disk recording/reproducing device 350-1 is “1” while the outputs of the other AND circuits 42 to 47 are all “0”.

Accordingly, at the factory, the magnetic disk recording/reproducing device 350-1 is set to as to determine only the output of the AND circuit 41 corresponding thereto to be valid and to determine the outputs of the other AND circuits 42 to 47 to be invalid. Then, when the output of the AND circuit 41 is “1”, the magnetic disk recording/reproducing device 350-1 recognizes that the signal transmitted as the currently received laser beam is one transmitted specifying the magnetic disk recording/reproducing device 350-1 itself, and receives serial data included in the signal, that is data obtained from the differentiating circuit 50, and writes the serial data in its magnetic disk drive 353 (HDD1), for example.

On the other hand, when the address level supplied from the integrating circuit 60 is the address level 2 for specifying the magnetic disk recording/reproducing device 350-2, the address level 2 is lower than the reference level 1 supplied to the comparator 21 but higher than the reference level 2 supplied to the comparator 22 as described above and the reference levels 2 to 6 are set to be lower than the reference level 1 in a stepwise manner in this order, and therefore the address level 2 is lower than the reference level 1 but higher than any of the other reference levels 2 to 6. Consequently, the comparator 21 determines that the address level is lower than the reference level while the other comparators 22 to 26 determine that the address level is higher than the respective reference levels 2 to 6, and thus the comparator 21 outputs “0” while all of the other comparators 22 to 26 output “1”. Consequently, the input supplied from the comparator 21 to the AND circuit 41 is “0”, and thus the AND circuit 41 outputs “0”. On the other hand, a signal obtained by inverting the output from the comparator 21 at the inverting circuit 31 is supplied to the AND circuit 42. Since the output from the comparator 21 is “0” as described above, the inverted signal of the output represents “1”. Further, the outputs from the other comparators 22 to 26, all of which are “1” as described above” are supplied to the AND circuit 42 in addition to the inverted signal from the inverting circuit 31. Consequently, the AND circuit 42 outputs “1”. On the other hand, a signal obtained by inverting the output from the comparator 22 at the inverting circuit 32 is supplied to the other AND circuits 43 to 47. Since the output from the comparator 22 is “1” as described above, the inverted signal of the output represents “0”. The AND circuits 43 to 47, to which the signal representing “0” is supplied, output “0”. Therefore, in this case, only the output of the AND circuit 42 corresponding to the magnetic disk recording/reproducing device 350-2 is “1” while the outputs of the other AND circuits 43 to 47 are all “0”.

Similarly, when the address level supplied from the integrating circuit 60 is any one of the address levels 3 to 6 for specifying corresponding one of the magnetic disk recording/reproducing devices 350-3 to 350-6, only the corresponding one of the AND circuits 43 to 46 outputs “1” while all the other AND circuits output “0”.

When the address level supplied from the integrating circuit 60 is the address level 7 for specifying the magnetic disk recording/reproducing device 350-7, the address level 7 is lower than any of the reference levels 1 to 6 supplied to the respective comparators 21 to 26. Consequently, all the comparators 21 to 26 output “0”. The outputs of the comparators 21 to 26 are directly input to all of the AND circuits 41 to 46, respectively, except for the AND circuit 47 corresponding to the magnetic disk recording/reproducing device 350-7. Since the comparators 21 to 26 output “0” as described above, all of the AND circuits 41 to 46 output “0”. On the other hand, signals obtained by inverting the outputs from the comparators 21 to 26 at the inverting circuits 31 to 36, respectively, are supplied to the AND circuit 47 corresponding to the magnetic disk recording/reproducing device 350-7, as illustrated in FIG. 4. Since the comparators 21 to 26 output “0” as described above, the inversion results at the inverting circuits 31 to 36 become all “1” and are supplied to the AND circuit 47. Thus, the AND circuit 47 outputs “1”. Therefore, in this case, only the output of the AND circuit 47 corresponding to the magnetic disk recording/reproducing device 350-7 is “1” while the outputs of the other AND circuits 41 to 46 are all “0”.

Accordingly, at the factory, each of the magnetic disk recording/reproducing devices 350-2 to 350-7 is set so as to determine only the output of one of the AND circuits 42 to 47 corresponding thereto to be valid and to determine the outputs of the other AND circuits to be invalid, as described above. Then, when the output of the valid AND circuit is “1”, the magnetic disk recording/reproducing device 350 recognizes that the signal transmitted by the currently received laser beam is one transmitted specifying the magnetic disk recording/reproducing device itself, and receives serial data included in the signal, that is data obtained from the differentiating circuit 50, and writes the serial data in its magnetic disk drive 353, for example.

As described above, in each of the magnetic disk recording/reproducing devices 350 in the information processing system according to the embodiment of the invention, a laser beam as an optical signal transmitted from the magnetic disk control device 330 via the optical transfer path 150 is converted into an electrical signal at the laser receiving element 230, an address level that is a direct-current component of the electrical signal is extracted at the integrating circuit 60, the address level is compared with the reference levels 1 to 6 at the comparators 21 to 26, respectively, and logic operation is performed on the comparison results at logic circuits comprising the AND circuits 41 to 47 and the inverting circuits 31 to 36, in the demodulator for reception, thereby the magnetic disk recording/reproducing device 350 determines whether or not the transmission signal of the laser beam is transmitted specifying the magnetic disk recording/reproducing device 350 itself.

Therefore, when the magnetic disk control device 330 accesses the magnetic disk recording/reproducing device 350 under the control of the magnetic disk control device 330 via the optical transfer path 150, the magnetic disk control device 330 outputs a laser beam having an address level corresponding to address data of the magnetic disk recording/reproducing device 350 to be accessed first to the optical transfer path 150. Then each magnetic disk recording/reproducing device 350, utilizing the above-described configuration, determines whether or not it is specified and accessed. The magnetic disk recording/reproducing device 350 that has thus recognized that it is accessed transmits a signal indicating that it is accessible as a response signal to the magnetic disk control device 330. In this manner, only this magnetic disk recording/reproducing device is entitled to subsequent passing of real data and performs operations such as writing real data (namely, serial data) into its magnetic disk drive 353.

Thereafter, when the magnetic disk control device 330 transfers a final end-of-transfer signal (status region) to the magnetic disk recording/reproducing device 350 and then outputs a laser beam having an address level for specifying another magnetic disk recording/reproducing device 350, the another magnetic disk recording/reproducing device 350 that is specified recognizes that it is accessed, and subsequent operations similar to those described above are performed.

Thus, according to the embodiment of the invention, the magnetic disk recording/reproducing device 350 to be accessed is specified by changing the intensity level of the laser beam that is output by the magnetic disk control device 330, and thus the time for outputting a signal required for specifying the magnetic disk recording/reproducing device 350 to be accessed can be effectively shortened, allowing high-speed access to the arbitrary magnetic disk recording/reproducing device 350. Since the magnetic disk recording/reproducing device 350 to be accessed can be specified in a short time in this way, high-speed data transfer is possible. Further, since high-speed data transfer is possible, the time for data transfer can be shortened, and thus an energy-saving effect can also be attained.

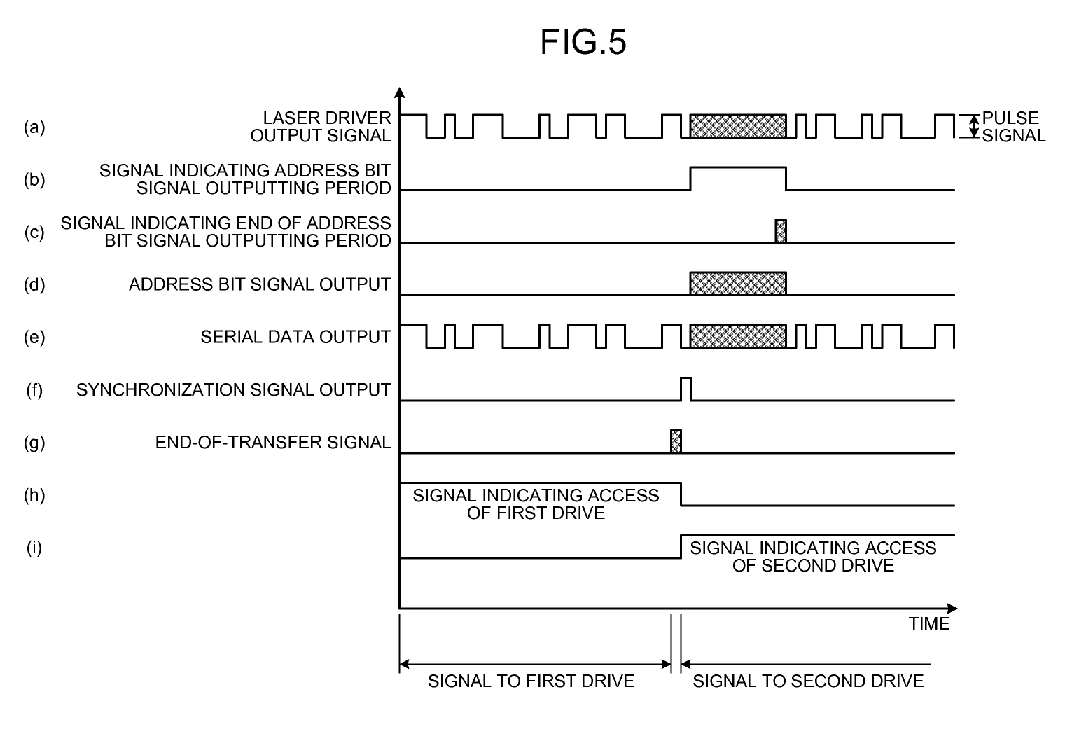

Next, a method for accessing an information processing device in an information processing system according to the embodiment of the invention is described with reference to time charts illustrated in FIGS. 5 and 6.

FIG. 5 is a time chart of signals in a magnetic disk control device that performs accesses in a method for accessing an information processing device according to a conventional technology presented for comparison.

The signal of FIG. 5(a) is a transmission signal of a laser beam (namely, a laser driver output signal, which is also a pulse signal) that is output from the magnetic disk control device, the first portion of which is transmitted to a first magnetic disk recording/reproducing device while the second portion of which is transmitted to a second magnetic disk recording/reproducing device.

The signal indicating address bit signal outputting period of FIG. 5(b) refers to a signal that indicates a period during which a signal having a series of address bits for specifying the second magnetic disk recording/reproducing device are output.

The signal indicating end of address bit signal outputting period of FIG. 5(c) refers to a signal that indicates an end of the period during which a signal having a series of address bits for specifying the second magnetic disk recording/reproducing device are output.

The address bit signal output of FIG. 5(d) refers to a signal having a series of address bits for specifying the second magnetic disk recording/reproducing device.

The serial data output of FIG. 5(e) refers to serial data that is real data transmitted to the first and second magnetic disk recording/reproducing devices.

The synchronization signal output of FIG. 5(f) refers to a synchronization signal indicating a timing at which the magnetic disk recording/reproducing device to be accessed is changed.

The end-of-transfer signal of FIG. 5(g) is a signal indicating that the output of serial data to the first magnetic disk recording/reproducing device is completed.

The signal indicating access of first drive of FIG. 5(h) is a signal indicating that the first magnetic disk recording/reproducing device is being accessed, and the signal indicating access of second drive of FIG. 5(i) is a signal indicating that the second magnetic disk recording/reproducing device is being accessed.

In FIG. 5, the signals other than the laser driver output signal of (a) are control signals within the magnetic disk control device.

Thus, in the conventional technology illustrated in FIG. 5, the serial data is output after the address bit signal outputting period in the laser driver output signal. This means that a period for outputting an address bit signal for specifying a magnetic disk recording/reproducing device to be accessed is required in transferring serial data that is real data.

In the magnetic disk control device, the signal indicating end of address bit signal outputting period is generated after the address bit signal outputting period, and by switching outputting of the address bit signal to outputting of the serial data at the timing of the signal indicating end of address bit signal transmission period, the address bit signal and the serial data are successively output as illustrated in FIG. 5.

FIG. 6 is a time chart for explaining exemplary operations in accessing each magnetic disk recording/reproducing device 350 from the magnetic disk control device 330 in the information processing system according to the embodiment of the invention.

The signal of FIG. 6(a) is a transmission signal of a laser beam emitted from the semiconductor laser 132 (namely, a signal output from the laser driver 131, which is also a pulse signal) in the modulator for transmission illustrated in FIG. 2 in the magnetic disk control device 330. The first portion of the transmission signal is transmitted to a first magnetic disk recording/reproducing device while the second portion of the transmission signal is transmitted to a second magnetic disk recording/reproducing device.

FIG. 6(b) illustrates an address level output from the level converter 122 in the modulator for transmission illustrated in FIG. 2 in the magnetic disk control device 330 (namely, an address level to be supplied to the adder 123 in FIG. 2). As illustrated in FIG. 6(b), an address level for specifying the first magnetic disk recording/reproducing device is output during the first period during which the transmission signal illustrated in FIG. 6(a) is addressed to the first magnetic disk recording/reproducing device (namely, the period illustrated at the bottom of FIG. 6 as “signal to first drive”), and an address level for specifying the second magnetic disk recording/reproducing device is output during the second period during which the transmission signal is addressed to the second magnetic disk recording/reproducing device (namely, the period illustrated at the bottom of FIG. 6 as “signal to second drive”).

FIG. 6(c) illustrates serial data that is real data transmitted to the first and second magnetic disk recording/reproducing devices (namely, serial data to be supplied to the adder 123 in FIG. 2). Serial data to be transferred to the first magnetic disk recording/reproducing device is output during the first period during which the transmission signal illustrated in FIG. 6(a) is addressed to the first magnetic disk recording/reproducing device (namely, the period illustrated at the bottom of FIG. 6 as “signal to first drive”), and serial data to be transferred to the second magnetic disk recording/reproducing device is output during the second period during which the transmission signal is addressed to the second magnetic disk recording/reproducing device (namely, the period illustrated at the bottom of FIG. 6 as “signal to second drive”).

FIG. 6(d) illustrates a synchronization signal indicating a timing at which the magnetic disk recording/reproducing device to be accessed is changed (namely, a synchronization signal to be supplied to the adder 123 in FIG. 2).

FIG. 6(e) illustrates an end-of-transfer signal indicating that the output of serial data to the first magnetic disk recording/reproducing device is completed.

The signal indicating access of first drive of FIG. 6(f) is a signal indicating that the first magnetic disk recording/reproducing device is being accessed, and the signal indicating access of second drive of FIG. 6(g) is a signal indicating that the second magnetic disk recording/reproducing device is being accessed.

In FIG. 6, the signals other than the laser driver output signal of (a) are control signals within the magnetic disk control device.

The laser driver output signal of FIG. 6(a) is a combined signal of a serial data component and an address level component, which are added by the adder 123 illustrated in FIG. 2 as described above. In this case, since the intensity level itself of the laser output emitted by the semiconductor laser 132 in FIG. 2 is a level corresponding to the address level, the signal level itself of the signal for transferring the serial data indicates the address data of the device to be accessed. In other words, the transmission signal includes the serial data and information on the address level in a form of an intensity level of the laser beam that is the transmission signal.

In the demodulator for reception (namely, the configuration illustrated in FIGS. 3 and 4) in each magnetic disk recording/reproducing device 350 that has received the transmission signal as illustrated in FIG. 6(a), the synchronization signal of FIG. 6(d) that is separated by the synchronization signal separating circuit 80 is supplied to the magnetic disk control LSI 210. Then, the period indicated by “signal to second drive” illustrated at the bottom of FIG. 6 is started, and the magnetic disk control device 330 changes the address level as illustrated in FIG. 6(b) (lowers the address level in the example of FIG. 6(b)) and adds the resulting address level to the pulse signal of the serial data at the adder 123 in the modulator for transmission (namely, the configuration of FIG. 2) in the magnetic disk control device 330 to thereby lower the total intensity level of the laser beam that is the laser driver output signal by a corresponding amount as illustrated in FIG. 6(a).

Consequently, the total intensity level of the laser beam received by the magnetic disk recording/reproducing device 350 on the receiving side also lowers by the corresponding amount, and the total output level of the laser receiving element 230 of the magnetic disk recording/reproducing device 350 also lowers by the corresponding amount. This output level is extracted at the integrating circuit 60 illustrated in FIG. 4 and used for the logic operations by the logic operation circuits comprising the comparators 21 to 26, the inverting circuits 31 to 36 and the AND circuits 41 to 47 to determine whether the transmission signal is transmitted specifying the magnetic disk recording/reproducing device 350.

When the determination is completed and the magnetic disk recording/reproducing device 350 recognizes that it is specified as a result of the determination, the magnetic disk control LSI 352 (210) of the magnetic disk recording/reproducing device 350 transmits a signal responding that it is ready for starting reception of real data as a response signal to the host magnetic disk control device 330, and then the magnetic disk control device 330 that has received the response signal starts transfer operation of serial data that is the real data to the magnetic disk recording/reproducing device 350.

A certain amount of time is required to extract the address level for specifying the magnetic disk recording/reproducing device 350 to be accessed by the integral operation of the integrating circuit 60 as described above. However, it is evident that the time can be significantly shortened as compared to the time required for outputting of the address bit signal in the conventional technology described with reference to FIG. 5(d).

At a timing of a pulse of the synchronization signal of FIG. 6(d) between the period of “signal to first drive” and the period of “signal to second drive” illustrated at the bottom of FIG. 6, the level of the laser beam of FIG. 6(a) becomes zero. This portion at which the laser beam level is zero is referred to as a synchronization signal region. Subsequently to the synchronization signal region, an arbitration region for extracting the address level in the magnetic disk recording/reproducing device 350 on the receiving side as described above is provided, followed by a data region of read/write for transferring the serial data that is the real data. After termination of the data region, a status region in which the end-of-transfer signal of FIG. 6(e) is transmitted is provided.

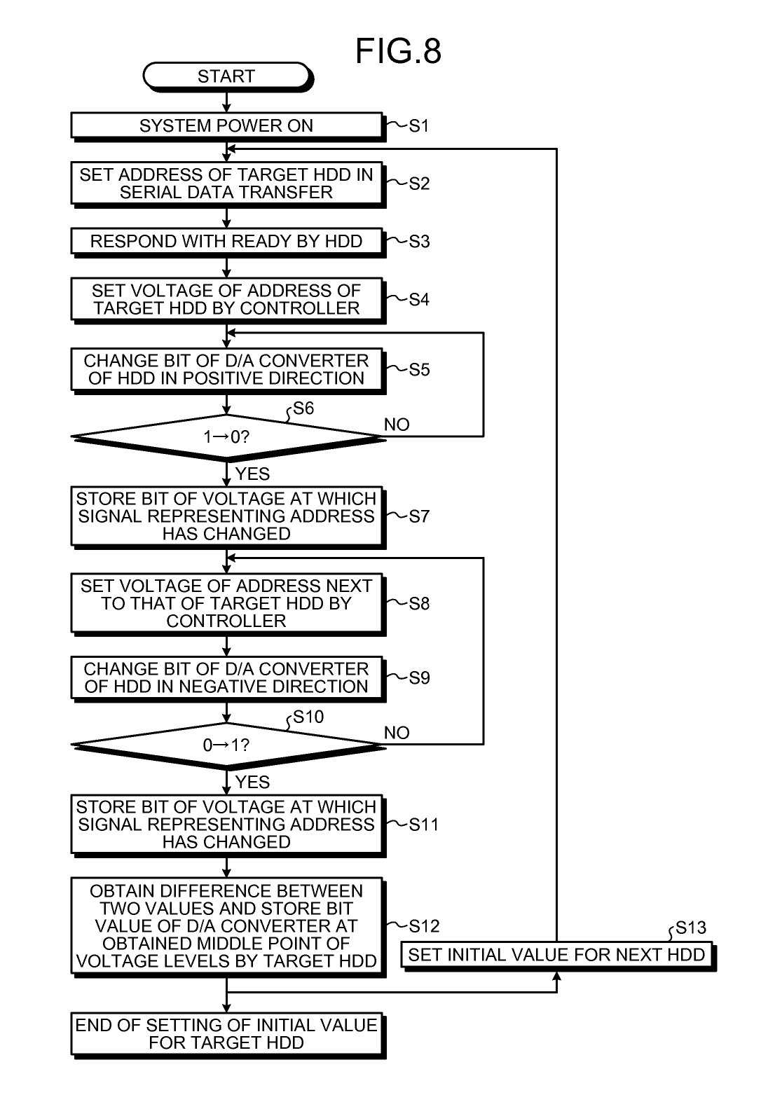

Next, an initial setting operation (calibration operation) performed at power-on in the information processing system according to the embodiment of the invention is described with reference to FIG. 8.

In an initial state at which the information processing system is initially powered on, bit data that represents voltage of the reference level for comparison with the address level for specifying each magnetic disk recording/reproducing device 350, which is determined when the information processing system is designed, is recorded in a memory of the magnetic disk control LSI 352 (210) of each magnetic disk recording/reproducing device 350. The bit data is supplied to the decoder 10 of the automatic adjusting circuit 70 illustrated in FIG. 4 via the address bus, and then supplied to each of the D/A converters 11 to 16 via the decoder 10. Then, as described above, the bit data is converted to a corresponding reference level at each of the D/A converters 11 to 16, and supplied to each corresponding comparator 21 to 26 for use in comparison with the address level supplied from the integrating circuit 60.

There would not be much problem if the number of the magnetic disk recording/reproducing devices 350 that are accessed by the magnetic disk control device 330 is small, but if the number is large, the number of the reference levels (namely, direct current voltage levels) is required to be correspondingly large for comparison with the respective address levels of the large number of magnetic disk recording/reproducing devices 350 and these reference levels have to be different from one another. Therefore, when the number of the magnetic disk recording/reproducing devices 350 to be accessed is large, it is necessary to reduce the differences between the reference levels. Consequently, there is a possibility that the results of comparison between the address levels and the reference levels contain errors due to factors such as variation in the characteristics of circuit elements constituting the automatic adjusting circuit 70, the comparators 21 to 26 and the like, or direct current voltage decay over signal transfer paths.

In order to prevent such errors, the initial setting operation (calibration operation) is performed at each magnetic disk recording/reproducing device 350.

As illustrated in FIG. 8, when the information processing system is powered on (S1), the address bit signal is first transferred from the host magnetic disk control device 330 to the magnetic disk recording/reproducing devices 350 under its control according to the conventional technology as illustrated in FIG. 5 (S2).

In this case, in the modulator for transmission (the configuration illustrated in FIG. 2) in the magnetic disk control device 330, the address bit signal is generated as serial data, to which a given direct voltage level supplied from the level converter 122 is added at the adder 123, and the addition result is transmitted to the optical transfer path 150 via the laser driver 131 and the semiconductor laser 132. In the demodulator for reception in each magnetic disk recording/reproducing device 350 that has received the transmitted signal, the address bit signal can be obtained as the serial data that is obtained by processing the received signal, which is acquired at the laser receiving element 230, at the differentiating circuit 50 and the synchronization signal separating circuit 80 as described in FIG. 4.

The magnetic disk recording/reproducing device that has recognized that it is accessed based on the address bit signal (hereinafter referred to as the target magnetic disk recording/reproducing device) transmits a ready signal as a response signal to the magnetic disk control device 330 (S3).

The magnetic disk control device 330 that has received the response signal outputs a laser beam with the address level of the target magnetic disk recording/reproducing device 350 (S4).

In the target magnetic disk recording/reproducing device 350 that has received the laser beam, in order to determine the direct current voltage level of the laser beam, the bit data, which is supplied from the decoder 10 to the D/A converter (hereinafter referred to as the D/A converter corresponding to the target magnetic disk recording/reproducing device) that outputs the reference level corresponding to the address level for specifying the target magnetic disk recording/reproducing device 350 among the D/A converters 11 to 16 in the automatic adjusting circuit 70 within the demodulator of the target magnetic disk recording/reproducing device 350, is gradually changed to thereby gradually raise the reference level obtained from the D/A converter (S5). The reference level corresponding to the address level for specifying the target magnetic disk recording/reproducing device 350 is, more specifically, a reference level (hereinafter referred to as the reference level corresponding to the target magnetic disk recording/reproducing device) set between the address level for specifying the target magnetic disk recording/reproducing device and the address level of the magnetic disk recording/reproducing device 350 of the next address (namely, the next lowest address level after the address level of the target magnetic disk recording/reproducing device).

As a result of changing the reference level in S5, the output of the comparator (hereinafter referred to as the comparator corresponding to the target magnetic disk recording/reproducing device) to which the reference level is supplied among the comparators 21 to 26 in the target magnetic disk recording/reproducing device 350 changes, and consequently, the output of the AND circuit (hereinafter referred to as the AND circuit corresponding to the target magnetic disk recording/reproducing device) that corresponds to the target magnetic disk recording/reproducing device among the AND circuits 41 to 47 in the demodulator of the target magnetic disk recording/reproducing device changes. By gradually raising the reference level, the change of the output of the AND circuit from “1” to “0” is detected (S6), and the bit data supplied to the D/A converter corresponding to the target magnetic disk recording/reproducing device when the change is detected is stored (S7).

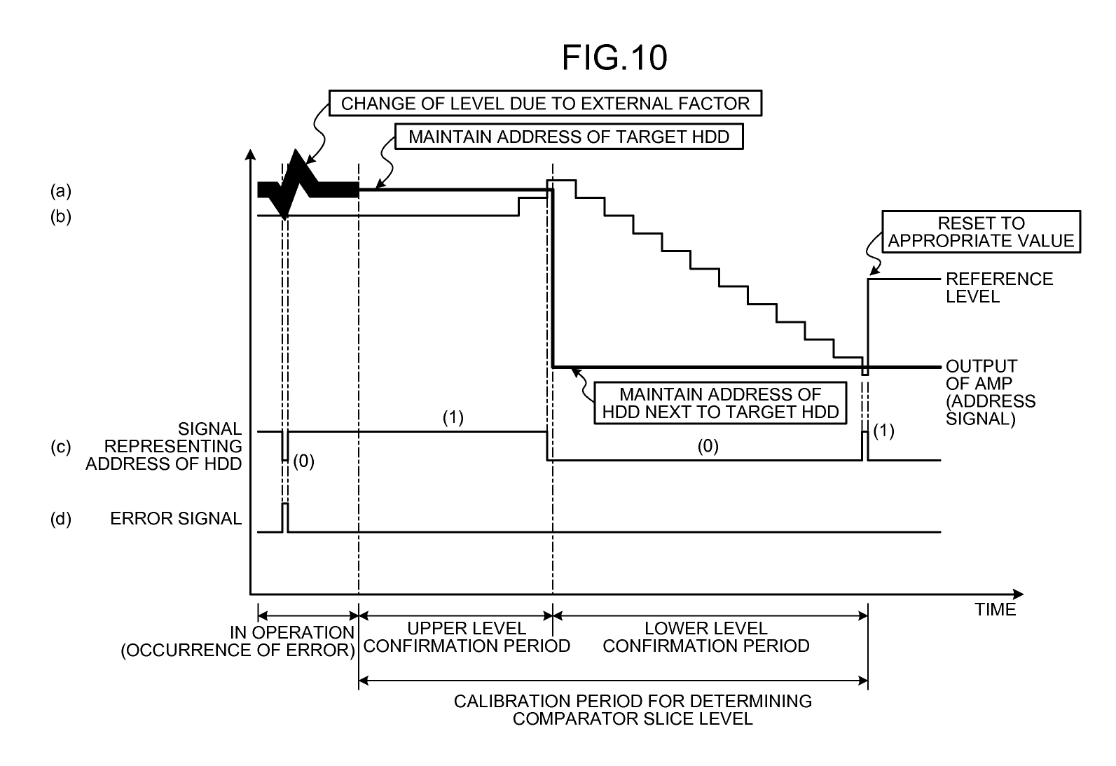

Specifically, in the example of FIG. 10 which will be described later, the direct current voltage level during “upper level confirmation period” illustrated at the bottom of FIG. 10, among the direct current voltage levels represented by a bold line of FIG. 10(a), corresponds to the address level of the target magnetic disk recording/reproducing device 350 while the direct current voltage level during “upper level confirmation period” illustrated at the bottom of FIG. 10, among the direct current voltage levels represented by a thin line of FIG. 10(b), corresponds to the reference level corresponding to the target magnetic disk recording/reproducing device. During the “upper level confirmation period” illustrated at the bottom of FIG. 10, the reference level represented by the thin line is lower than the address level represented by the bold line, and therefore, the output of the comparator corresponding to the target magnetic disk recording/reproducing device is “1”, and the output of the AND circuit corresponding to the target magnetic disk recording/reproducing device is “1”, that is, the level illustrated in FIG. 10(c) is high. As illustrated in the end portion of the “upper level confirmation period” illustrated at the bottom of FIG. 10, when the reference level becomes larger than the address level as a result of gradually raising the reference level, the output of the comparator is inverted to “0”, and consequently, the output of the AND circuit also becomes “0”.

Therefore, the reference level at the time when the output of the AND circuit corresponding to the target magnetic disk recording/reproducing device turns from “1” to “0” can be regarded as a level substantially equal to the address level, namely the address level of the target magnetic disk recording/reproducing device 350.

Next, the magnetic disk control device 330 outputs a laser beam of an address level of the magnetic disk recording/reproducing device 350 with an address next to the address of the target magnetic disk recording/reproducing device 350 (S8).

The address level of the magnetic disk recording/reproducing device 350 with an address next to the address of the target magnetic disk recording/reproducing device 350 refers to an address level next to the address level of the target magnetic disk recording/reproducing device 350 when the address levels of the magnetic disk recording/reproducing devices 350 are arranged in descending order. Therefore, the address level of the magnetic disk recording/reproducing device 350 with an address next to the address of the target magnetic disk recording/reproducing device 350 refers to the next lowest address level after that address level of the target magnetic disk recording/reproducing device 350.

In the target magnetic disk recording/reproducing device 350 that has received the laser beam output from the magnetic disk control device 330 in S8, in order to determine the direct current voltage level of the laser beam, the bit data, which is supplied from the decoder 10 to the D/A converter corresponding to the target magnetic disk recording/reproducing device, is gradually changed to thereby gradually lower the reference level obtained from the D/A converter (S9).

As a result of changing the reference level in S9, the output of the comparator corresponding to the target magnetic disk recording/reproducing device to which the reference level is supplied among the comparators 21 to 26 in the demodulator of the target magnetic disk recording/reproducing device 350 changes, and consequently, the output of the AND circuit corresponding to the target magnetic disk recording/reproducing device changes. By gradually lowering the reference level, the change of the output of the AND circuit from “0” to “1” is detected (S10), and the bit data supplied to the D/A converter corresponding to the target magnetic disk recording/reproducing device when the change is detected is stored (S11).

In this case, in the example of FIG. 10, the direct current voltage level during “lower level confirmation period” illustrated at the bottom of FIG. 10, among the direct current voltage levels represented by a bold line of FIG. 10(a), corresponds to the address level of the magnetic disk recording/reproducing device of an address next to the target magnetic disk recording/reproducing device 350 while the direct current voltage level during “lower level confirmation period” illustrated at the bottom of FIG. 10, among the direct current voltage levels represented by a thin line of FIG. 10(b), corresponds to the reference level corresponding to the target magnetic disk recording/reproducing device. During the “lower level confirmation period” illustrated at the bottom of FIG. 10, the reference level represented by the thin line is higher than the address level represented by the bold line, and therefore, the output of the comparator corresponding to the target magnetic disk recording/reproducing device is “0”, and the output of the AND circuit corresponding to the target magnetic disk recording/reproducing device is “0”, that is, the level illustrated in FIG. 10(c) is low. As illustrated in the end portion of the “lower level confirmation period” illustrated at the bottom of FIG. 10, when the reference level becomes smaller than the address level as a result of gradually lowering the reference level, the output of the comparator is inverted to “1”, and consequently, the output of the AND circuit also becomes “1”.

Therefore, the reference level at the time when the output of the AND circuit corresponding to the target magnetic disk recording/reproducing device turns from “0” to “1” can be regarded as a level substantially equal to the address level, namely the address level of the magnetic disk recording/reproducing device 350 with the address next to the address of the target magnetic disk recording/reproducing device 350.

Next, a middle value Vadd of the direct current voltage levels Vh and Vl represented by the bit data stored at S7 and S11, respectively, is calculated (by the following expression), and using the direct current voltage level of the obtained middle value as the reference level corresponding to the target magnetic disk recording/reproducing device 350, the bit data representing the reference level is stored in a memory as bit data to be supplied to the D/A converter corresponding to the target magnetic disk recording/reproducing device (S12):

Vadd=((Vh−Vl)÷2)+Vl

The target magnetic disk recording/reproducing device 350 is sequentially switched and the operations in S2 to S12 are performed for each target magnetic disk recording/reproducing device 350 (S13).

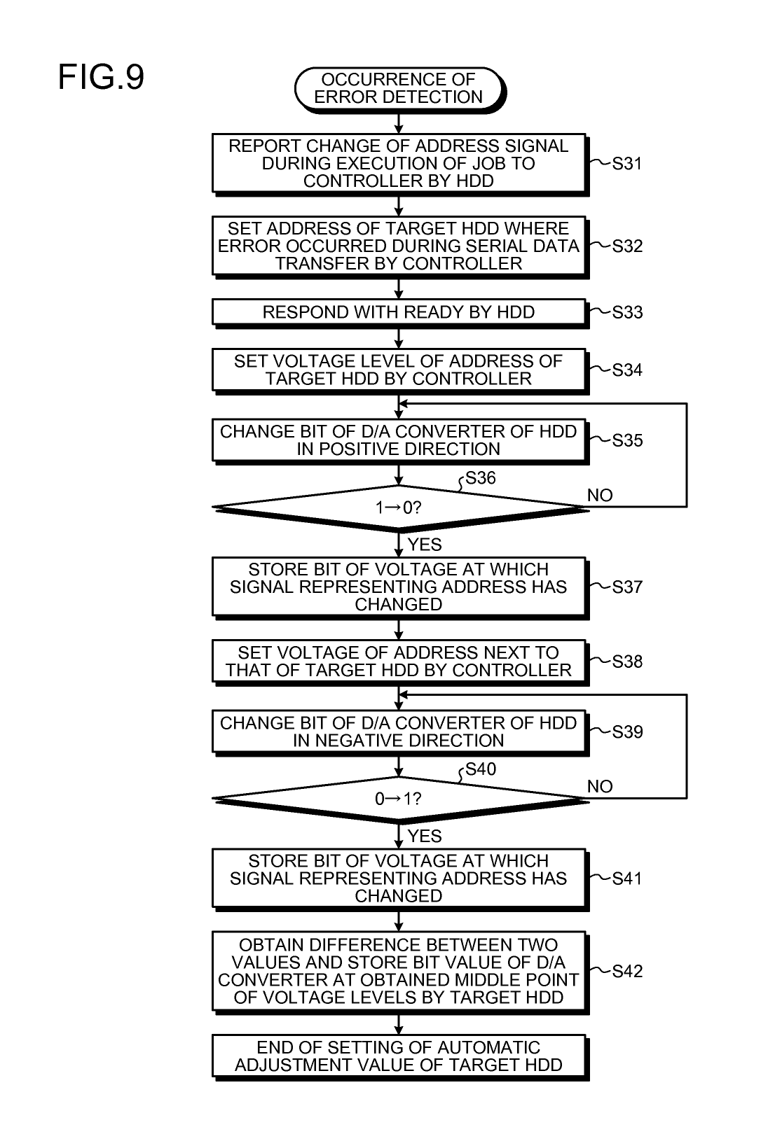

An operation (calibration operation) for adjusting a reference level for specifying the magnetic disk recording/reproducing device 350 at the magnetic disk recording/reproducing device 350 in the information processing system according to the embodiment of the invention is described below with reference to FIGS. 9 and 10. The calibration operation is automatically performed upon occurrence of an error such as an error that an address level transmitted from the magnetic disk control device 330 changes to a level out of the address level specifying this magnetic disk recording/reproducing device 350 while this magnetic disk recording/reproducing device 350 is performing an operation such as data writing to its magnetic disk drive according to an instruction from the magnetic disk control device 330.

Specifically, the meaning of “an address level transmitted from the magnetic disk control device 330 changes” described above is that, since the intensity level of the laser beam that is output to the optical transfer path 150 is obtained by adding the address level and the serial data at the adder 123 in the modulator for transmission in the magnetic disk control device 330, the total level of the transmission signal as a result of adding the serial data changes due to the change of the address level by an amount corresponding to the change of the address level, as described above with reference to FIG. 6(a) and the like. In addition, such a change of the total level of the transmission signal can be obtained as a change of the address level obtained by the integral operation by the integrating circuit 60 of the demodulator for reception in the magnetic disk recording/reproducing device 350, as described above with reference to FIG. 4.

In S31 of FIG. 9, when the magnetic disk recording/reproducing device 350 detects an occurrence of an error as described above, the magnetic disk recording/reproducing device 350 transmits a signal reporting the detection to the magnetic disk control device 330.

For example, the error is a case where the address level for specifying the magnetic disk recording/reproducing device 350, which is transmitted from the magnetic disk control device 330, becomes lower than the reference level corresponding to the magnetic disk recording/reproducing device 350 (namely, a reference level set between the address level of the magnetic disk recording/reproducing device and the address level of a magnetic disk recording/reproducing device of a next address that is the next lowest address level; the same definition is applicable in the description below) due to a change of the address level transmitted from the magnetic disk control device 330 to the magnetic disk recording/reproducing device 350 caused by a certain external factor, as illustrated in FIG. 10(a) during the period of “in operation (occurrence of error)” described at the bottom of FIG. 10.

In such a case, the output of the comparator corresponding to the magnetic disk recording/reproducing device 350 (namely, the comparator to which the reference level corresponding to the magnetic disk recording/reproducing device is supplied; the same definition is applicable in the description below), among the comparators 21 to 26 in the demodulator for reception in the magnetic disk recording/reproducing device 350, is inverted from “1” to “0”, and consequently, the output of the AND circuit corresponding to the magnetic disk recording/reproducing device, among the AND circuits 41 to 47, turns from “1” to “0” (FIG. 10(c)). This is detected by the magnetic disk control LSI 210 (352) of the magnetic disk recording/reproducing device 350 (FIG. 10(d)), and the magnetic disk recording/reproducing device 350 transmits a signal reporting the detection to the magnetic disk control device 330 according to an instruction from the magnetic disk control LSI as described above.

Subsequent operations are the same as those in S2 to S12 of FIG. 8 described above. The operations in S32 to S42 of FIG. 9 respectively correspond to those in S2 to S12 of FIG. 8.

Specifically, in S32 of FIG. 9, an address bit signal is transferred from the magnetic disk control device 330 to the magnetic disk recording/reproducing device 350 according to the conventional technology described above with reference to FIG. 5.

In S33, when the magnetic disk recording/reproducing device 350 recognizes that it is accessed by the address bit signal transmitted from the magnetic disk control device 330 in S32, the magnetic disk recording/reproducing device transmits a ready signal as a response signal to the magnetic disk control device 330 (S33).

The magnetic disk control device 330 that has received the response signal outputs a laser beam with the address level of the magnetic disk recording/reproducing device 350 (S34).

In the demodulator for reception in the magnetic disk recording/reproducing device 350 that has received the laser beam, in order to determine the direct current voltage level obtained from the laser beam by the laser receiving element 230, the bit data, which is supplied from the decoder 10 to the D/A converter (hereinafter referred to as the D/A converter corresponding to the magnetic disk recording/reproducing device) that outputs the reference level corresponding to the address level for specifying the magnetic disk recording/reproducing device 350 among the D/A converters 11 to 16 in the automatic adjusting circuit 70, is gradually changed to thereby gradually raise the reference level obtained from the D/A converter (S35). The reference level corresponding to the address level for specifying the magnetic disk recording/reproducing device 350 is, more specifically, a reference level corresponding to the magnetic disk recording/reproducing device, which is set between the address level for specifying the magnetic disk recording/reproducing device and the address level of the magnetic disk recording/reproducing device 350 of the next address (namely, the next lowest address level after the address level of the magnetic disk recording/reproducing device).

As a result of changing the reference level in S35, the output of the comparator (namely, the comparator corresponding to the magnetic disk recording/reproducing device) to which the reference level is supplied among the comparators 21 to 26 in the magnetic disk recording/reproducing device 350 changes, and consequently, the output of the AND circuit corresponding to the magnetic disk recording/reproducing device among the AND circuits 41 to 47 in the demodulator of the magnetic disk recording/reproducing device changes. By gradually raising the reference level, the change of the output of the AND circuit from “1” to “0” is detected (S36), and the bit data supplied to the D/A converter corresponding to the magnetic disk recording/reproducing device when the change is detected is stored (S37).

Specifically, in the example of FIG. 10 which will be described later, the direct current voltage level during the “upper level confirmation period” illustrated at the bottom of FIG. 10, among the direct current voltage levels represented by the bold line of FIG. 10(a), corresponds to the address level corresponding to the magnetic disk recording/reproducing device 350 while the direct current voltage level during the “upper level confirmation period” illustrated at the bottom of FIG. 10, among the direct current voltage levels represented by the thin line of FIG. 10(b), corresponds to the reference level corresponding to the magnetic disk recording/reproducing device. During the “upper level confirmation period” illustrated at the bottom of FIG. 10, the reference level represented by the thin line is lower than the address level represented by the bold line, and therefore, the output of the comparator corresponding to the magnetic disk recording/reproducing device is “1”, and the output of the AND circuit corresponding to the magnetic disk recording/reproducing device is “1”, that is, the level illustrated in FIG. 10(c) is high. As illustrated in the end portion of the “upper level confirmation period” illustrated at the bottom of FIG. 10, when the reference level becomes larger than the address level as a result of gradually raising the reference level, the output of the comparator is inverted to “0”, and consequently, the output of the AND circuit also becomes “0”.

Therefore, the reference level at the time when the output of the AND circuit corresponding to the magnetic disk recording/reproducing device turns from “1” to “0” can be regarded as a level substantially equal to the address level of the magnetic disk recording/reproducing device 350.

Next, the magnetic disk control device 330 outputs a laser beam of an address level of the magnetic disk recording/reproducing device 350 with an address next to the address of the magnetic disk recording/reproducing device 350 (S38).

The address level of the magnetic disk recording/reproducing device 350 with an address next to the address of the magnetic disk recording/reproducing device 350 refers to an address level next to the address level of the magnetic disk recording/reproducing device 350 when the address levels of the magnetic disk recording/reproducing devices 350 are arranged in descending order. Therefore, the address level of the magnetic disk recording/reproducing device 350 with an address next to the address of the magnetic disk recording/reproducing device 350 refers to the next lowest address level after the address level of the magnetic disk recording/reproducing device 350.

In the magnetic disk recording/reproducing device 350 that has received the laser beam output from the magnetic disk control device 330 in S38, in order to determine the direct current voltage level of the laser beam, the bit data, which is supplied from the decoder 10 to the D/A converter corresponding to the magnetic disk recording/reproducing device, is gradually changed to thereby gradually lower the reference level obtained from the D/A converter (S39).

As a result of changing the reference level in S39, the output of the comparator to which the reference level is supplied (thus referred to as the comparator corresponding to the magnetic disk recording/reproducing device) among the comparators 21 to 26 in the demodulator of the magnetic disk recording/reproducing device 350 changes, and consequently, the output of the AND circuit corresponding to the magnetic disk recording/reproducing device changes. By gradually lowering the reference level, the change of the output of the AND circuit from “0” to “1” is detected (S40), and the bit data supplied to the D/A converter corresponding to the magnetic disk recording/reproducing device when the change is detected is stored (S41).

In the example of FIG. 10, the direct current voltage level during the “lower level confirmation period” illustrated at the bottom of FIG. 10, among the direct current voltage levels represented by the bold line of FIG. 10(a), corresponds to an address level of the magnetic disk recording/reproducing device 350 of an address next to the magnetic disk recording/reproducing device 350 while the direct current voltage level during the “lower level confirmation period” illustrated at the bottom of FIG. 10, among the direct current voltage levels represented by the thin line of FIG. 10(b), corresponds to the reference level corresponding to the magnetic disk recording/reproducing device. During the “lower level confirmation period” illustrated at the bottom of FIG. 10, the reference level represented by the thin line is higher than the address level represented by the bold line, and therefore, the output of the comparator corresponding to the magnetic disk recording/reproducing device is “0”, and the output of the AND circuit corresponding to the magnetic disk recording/reproducing device is “0”, that is, the level illustrated in FIG. 10(c) is low. As illustrated in the end portion of the “lower level confirmation period” illustrated at the bottom of FIG. 10, when the reference level becomes smaller than the address level as a result of gradually lowering the reference level, the output of the comparator is inverted to “1”, and consequently, the output of the AND circuit also becomes “1”.

Therefore, the reference level at the time when the output of the AND circuit corresponding to the magnetic disk recording/reproducing device turns from “0” to “1” can be regarded as a level substantially equal to the address level of the magnetic disk recording/reproducing device 350 with the address next to the address of the magnetic disk recording/reproducing device 350.

Next, a middle value Vadd of the direct current voltage levels Vh and Vl represented by the bit data stored at S37 and S41, respectively, is calculated (as the following expression), and using the direct current voltage level of the obtained middle value as the reference level corresponding to the magnetic disk recording/reproducing device 350, the bit data representing the reference level is stored in a memory as bit data to be supplied to the D/A converter corresponding to the magnetic disk recording/reproducing device (S42):

Vadd=((Vh−Vl)÷2)+Vl

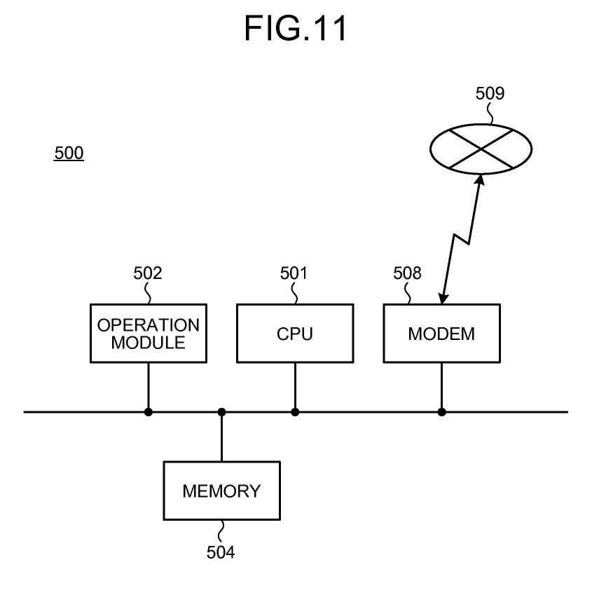

FIG. 11 is a block diagram illustrating an exemplary hardware configuration of a computer mounted on each magnetic disk control LSI 352 comprised in the magnetic disk control device 330 or in each magnetic disk recording/reproducing device 350 in the information processing system according to the embodiment of the invention.

As illustrated in FIG. 11, a computer 500 comprises a CPU 501 for performing various operations by executing instructions constituting given programs, an operation module 502, a memory 504 for storing programs executed by the CPU 501, data and the like or for use as a working region, and a modem 508 for functions such as downloading programs externally via a communication network 509 such as Internet, a LAN. The memory 504 roughly includes a so-called memory (RAM, etc.) and a non-volatile memory (neither of which is illustrated).

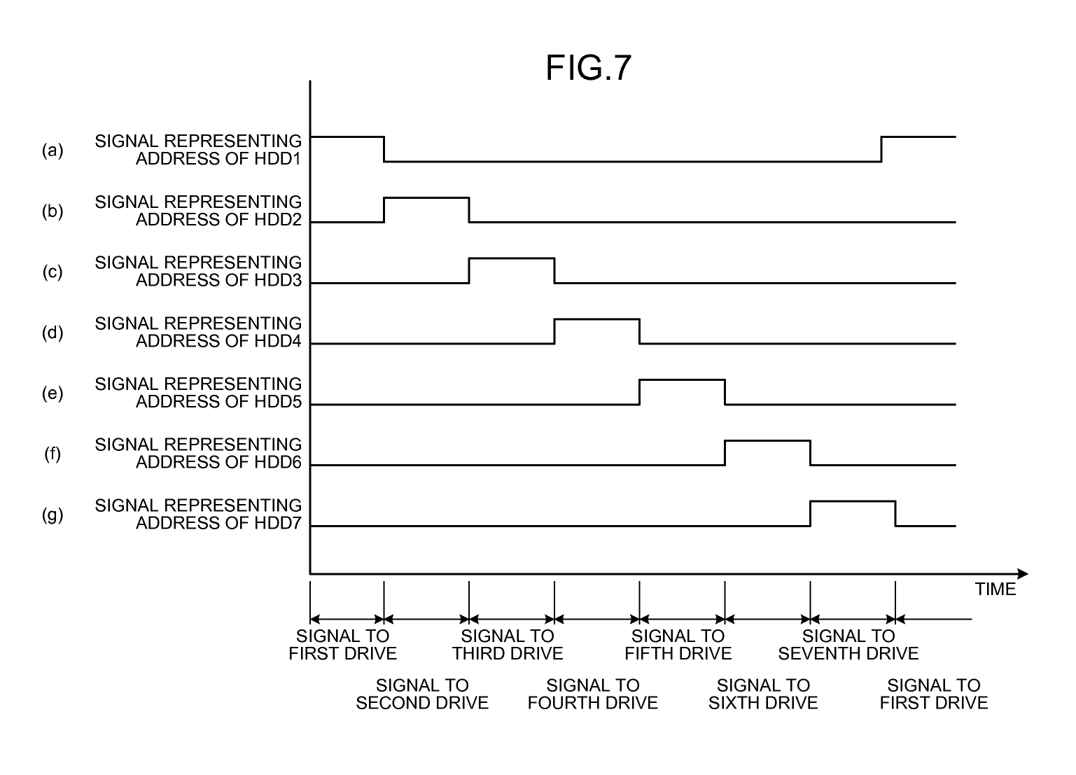

In the computer 500, before product shipment, programs for performing the operations of the magnetic disk control device 330 or each magnetic disk recording/reproducing device 350 described above with reference to FIGS. 1 to 10 (in particular, the time charts of FIGS. 6, 7 and 10 and the flowcharts of FIGS. 8 and 9) are stored as firmware, for example, in the non-volatile memory included in the memory 504.

These programs are loaded, as necessary, into the so-called memory (RAM, etc.) included in the memory 504 and executed by the CPU 501, thereby the operations of the magnetic disk control device 330 or each magnetic disk recording/reproducing device 350 are implemented.

Replacement, upgrading and the like of the programs are implemented by downloading a relevant program via the communication network (LAN) 509 using the modem 508.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising a plurality of information processing devices connected to one another and configured to transmit data to, and receive data from, one another, a first information processing device among the plurality of information processing devices comprising:
a determination controller configured to determine whether an address level in a transmission signal from a second information processing device among the information processing devices is addressing the first information processing device based on information on the address level, and
a data receiver configured to receive real data in the received transmission signal when the determination controller determines that the address level in the transmission signal is addressing the first information processing device, and
the second information processing device comprising,
an address-data converter configured to convert address data addressing the first information processing device to a corresponding address level, and
a transmitter configured to transmit the transmission signal comprising information on the address level from the address-data converter and the real data for the first information processing device.

2. The information processing system of claim 1, wherein
the transmission signal comprises an optical signal, and the address level corresponding to the address data addressing the first information processing device corresponds to an intensity level of the optical signal.

3. The information processing system of claim 1, further comprising:
a magnetic disk drive, wherein
the real data in the transmission signal from the second information processing device comprises data to be written on an information recording medium of the magnetic disk drive.

4. The information processing system of claim 1, wherein
the transmission signal from the transmitter of the second information processing device comprises an addition of the address level corresponding to the address data addressing the first information processing device and the real data for the first information processing device.

5. The information processing system of claim 1, wherein
the determination controller comprises a plurality of comparators configured to compare the address level with reference levels that are different from one another, the reference levels being set to levels between adjacent address levels among address levels corresponding to address data addressing the information processing devices, and the determination controller being configured to determine whether the address level is addressing the first information processing device based on comparison outputs from the comparators.

6. The information processing system of claim 5, further comprising:
an adjusting module configured to adjust the reference level of the comparator of the determination controller by using an address level corresponding to address data addressing a third information processing device, the address level being next to the address level corresponding to the address data addressing the first information processing device.

7. A method for accessing an information processing device by which a first information processing device among a plurality of information processing devices accesses a second information processing device in an information processing system in which the information processing devices are connected to one another and are configured to transmit data to, and receive data from, one another, the method comprising:
converting, by the first information processing device, address data addressing the second information processing device to a corresponding address level;
transmitting, by the first information processing device, a transmission signal comprising information on the address level and real data for the second information processing device;
determining, by the second information processing device, whether the address level is addressing the second information processing device based on the information on the address level in the transmission signal from the first information processing device; and
receiving, by the second information processing device, the real data in the transmission signal if it is determined that the address level in the transmission signal is addressing the second information processing device.

8. The method for accessing an information processing device of claim 7, wherein
the transmission signal comprises an optical signal, and the address level corresponding to the address data addressing the second information processing device corresponds to an intensity level of the optical signal.

9. The method for accessing an information processing device of claim 7, wherein
the second information processing device comprises a magnetic disk drive, and
the real data in the transmission signal comprises data to be written on an information recording medium of the magnetic disk drive.

10. The method for accessing an information processing device of claim 7, wherein
the transmission signal comprises an addition of the address level corresponding to the address data addressing the second information processing device and the real data for the second information processing device.

11. The method for accessing an information processing device of claim 7, wherein
the determining comprises determining whether the address level is addressing the second information processing device based on comparison outputs from comparators configured to compare the address level with reference levels that are different from one another, the reference levels that are different from one another being set to levels between adjacent address levels among address levels corresponding to address data addressing the information processing devices.

12. The method for accessing an information processing device of claim 11, further comprising:
adjusting, by the second information processing device, the reference level of the comparator by using an address level corresponding to address data addressing the third information processing device, the address level being next to the address level corresponding to the address data addressing the second information processing device.
